(19) United States
(12) Patent Application Publication
(10) Pub. No.: US 2025/0042483 A1
(43) Pub. Date: Feb. 6, 2025

(54) VEHICLE SPOILER MOVEMENT CONTROL SYSTEMS

(71) Applicant: GM GLOBAL TECHNOLOGY OPERATIONS LLC, Detroit, MI (US)

(72) Inventors: Gursimran CHAUHAN, Courtice (CA); REmy Richard Martial AUDEL, Toronto (CA)

(21) Appl. No.: 18/363,335

(22) Filed: Aug. 1, 2023

(51) Int. Cl. B62D 35/00

(52) U.S. Cl. CPC B62D 35/007

(57) ABSTRACT

A vehicle spoiler control system includes a vehicle spoiler, at least one spoiler actuator configured to move the vehicle spoiler relative to a surface of a vehicle, one or more vehicle sensors configured to obtain at least one vehicle parameter, and a vehicle control module configured to determine a spoiler pinch risk condition according to the at least one vehicle parameter, control the spoiler actuator to operate with torque less than or equal to a first torque value in response to a determination that the spoiler pinch risk condition is greater than a threshold, and control the spoiler actuator to operate with torque less than or equal to a second torque value in response to a determination that the spoiler pinch risk condition is greater less than the threshold, wherein the second torque value is greater than the first torque value.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Some vehicles include spoilers for aesthetics and/or aerodynamic performance. In some cases, one or more actuators are used to raise and lower the vehicle spoiler relative to a surface of vehicle, such as a liftgate of the vehicle on which the spoiler is mounted. In some situations, movement of the vehicle spoiler may create a pinch hazard to an occupant of the vehicle or another person adjacent the vehicle.

### SUMMARY

A vehicle spoiler control system includes a vehicle spoiler, at least one spoiler actuator configured to move the vehicle spoiler relative to a surface of a vehicle, one or more vehicle sensors configured to obtain at least one vehicle parameter, and a vehicle control module configured to determine a spoiler pinch risk condition according to the at least one vehicle parameter, control the spoiler actuator to operate with torque less than or equal to a first torque value in response to a determination that the spoiler pinch risk condition is greater than a threshold, and control the spoiler actuator to operate with torque less than or equal to a second torque value in response to a determination that the spoiler pinch risk condition is greater less than the threshold, wherein the second torque value is greater than the first torque value.

In other features, the at least one vehicle parameter includes at least one of a vehicle speed, a vehicle transmission state, a vehicle liftgate status, a spoiler end stop position, or a spoiler angle.

In other features, the one or more vehicle sensors are configured to obtain a current of the at least one spoiler actuator, and the vehicle control module is configured to compare the current of the at least one spoiler actuator to an overcurrent threshold to determine whether a pinch condition of the vehicle spoiler has occurred.

In other features, in response to a determination that the pinch condition of the vehicle spoiler has occurred, the vehicle control module is configured to stop operation of the at least one spoiler actuator to inhibit further movement or rotation of the vehicle spoiler.

In other features, in response to a determination that the pinch condition of the vehicle spoiler has occurred, the vehicle control module is configured to reverse operation of the spoiler actuator to move the vehicle spoiler to a target pinch relief position to relieve the pinch condition of the vehicle spoiler.

In other features, the vehicle control module is configured to use skip detection logic to determine whether an output shaft of the spoiler actuator and a motor angle of the spoiler actuator are misaligned, to stop operation the spoiler actuator to inhibit further movement or rotation of the vehicle spoiler.

In other features, the one or more vehicle sensors are configured to obtain one or more spoiler actuator parameters, and the vehicle control module is configured to determine whether a pinch condition of the vehicle spoiler has occurred according to the one or more spoiler actuator parameters.

In other features, in response to a determination that the pinch condition of the vehicle spoiler has occurred, the vehicle control module is configured to stop operation the spoiler actuator to inhibit further movement or rotation of the vehicle spoiler.

In other features, the at least one spoiler actuator includes a first spoiler actuator coupled to lift a first portion of the vehicle spoiler, and a second spoiler actuator coupled to lift a second portion of the vehicle spoiler, the second portion located adjacent a different end of the vehicle spoiler than the first portion.

In other features, the one or more spoiler actuator parameters include at least one of a motor speed of at least one of the first spoiler actuator or the second spoiler actuator, a stopped motor of at least one of the first spoiler actuator or the second spoiler actuator, or a misalignment of the first spoiler actuator and the second spoiler actuator.

In other features, the at least one spoiler actuator is configured to move the vehicle spoiler from a deployed position to a stowed position, and the vehicle spoiler is closer to the surface of the vehicle in the stowed position than in the deployed position.

In other features, the vehicle control module is configured to identify a first end stop of the vehicle spoiler in the stowed position and a second end stop of the vehicle spoiler in the deployed position, and the vehicle control module is configured to determine the spoiler pinch risk condition at least in part according to a position of the vehicle spoiler relative to at least one of the first end stop and the second end stop.

A vehicle spoiler control system includes a vehicle spoiler, at least one spoiler actuator configured to move the vehicle spoiler relative to a surface of a vehicle, one or more vehicle sensors configured to obtain at least one vehicle parameter, and a vehicle control module configured to obtain a current of the at least one spoiler actuator, compare the current of the at least one spoiler actuator to an overcurrent threshold to determine whether a pinch condition of the vehicle spoiler has occurred, and in response to a determination that the pinch condition of the vehicle spoiler has occurred, stop operation of the at least one spoiler actuator to inhibit further movement or rotation of the vehicle spoiler.

In other features, in response to a determination that the pinch condition of the vehicle spoiler has occurred, the vehicle control module is configured to reverse operation of the spoiler actuator to move the vehicle spoiler to a target pinch relief position to relieve the pinch condition of the vehicle spoiler.

In other features, the vehicle control module is configured to use skip detection logic to determine whether an output shaft of the spoiler actuator and a motor angle of the spoiler actuator are misaligned, to stop operation the spoiler actuator to inhibit further movement or rotation of the vehicle spoiler.

In other features, the one or more vehicle sensors are configured to obtain one or more spoiler actuator parameters, and the vehicle control module is configured to determine whether a pinch condition of the vehicle spoiler has occurred according to the one or more spoiler actuator parameters.

In other features, in response to a determination that the pinch condition of the vehicle spoiler has occurred, the vehicle control module is configured to stop operation the spoiler actuator to inhibit further movement or rotation of the vehicle spoiler.

A method of controlling movement of a vehicle spoiler includes moving, by at least one spoiler actuator, a vehicle spoiler relative to a surface of a vehicle, obtaining, via one or more vehicle sensors, at least one vehicle parameter, determining a spoiler pinch risk condition according to the at least one vehicle parameter, controlling the spoiler actuator to operate with torque less than or equal to a first torque value in response to a determination that the spoiler pinch risk condition is greater than a threshold, and controlling the spoiler actuator to operate with torque less than or equal to a second torque value in response to a determination that the spoiler pinch risk condition is greater less than the threshold, wherein the second torque value is greater than the first torque value.

In other features, the method includes obtaining, by the one or more vehicle sensors, a current of the at least one spoiler actuator, comparing the current of the at least one spoiler actuator to an overcurrent threshold to determine whether a pinch condition of the vehicle spoiler has occurred, and in response to a determination that the pinch condition of the vehicle spoiler has occurred, stop operation of the at least one spoiler actuator to inhibit further movement or rotation of the vehicle spoiler.

In other features, the at least one vehicle parameter includes at least one of a vehicle speed, a vehicle transmission state, a vehicle liftgate status, a spoiler end stop position, or a spoiler angle.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example embodiment of a vehicle including a control system for controlling movement of a vehicle spoiler.

FIG. 2 is a block diagram of an example system where a vehicle spoiler is in a deployed position.

FIG. 3 is a block diagram of where the vehicle spoiler of FIG. 2 is in a stowed position.

FIG. 4 is a block diagram of a control system for determining whether a pinch risk condition is present based on vehicle parameters.

FIG. 5 is a block diagram of a control system for determining whether a pinch hazard event has occurred.

FIG. 6 is flowchart depicting an example method of controlling movement of a vehicle spoiler.

In the drawings, reference numbers may be reused to identify similar and/or identical elements.

### DETAILED DESCRIPTION

Some example embodiments include a control system solution which is used to detect pinch hazards or pinch risk conditions of a vehicle spoiler. The pinch system may detect these conditions and modify operation of actuators of spoiler, while an active spoiler is in operation (e.g., while the spoiler is moving between positions) without the need for external hardware or external pinch event sensors.

Example control systems may be configured to identify boundaries of spoiler movement in the system, to determine pinch hazard conditions using vehicle data (e.g., to dynamically change motor torque settings of a spoiler actuator), and monitor motor characteristics to accurately determine when spoiler pinch events occur to provide protection and comfort for occupants or persons adjacent the vehicle.

For example, a vehicle control module may process motor current data of a spoiler actuator to dynamically calculate an over current pinch threshold, based on instantaneous performance of the motor and/or other components of the system. If the vehicle control module detects that the average motor current of the spoiler actuator has exceeded an over current threshold during movement of the vehicle spoiler, then a ‘Pinch Detected’ flag is set by the vehicle control module to turn off the motor of the spoiler actuator. After detecting the spoiler pinch event, the vehicle control module may calculate a new target position to relieve the pinch condition, based on the direction and a location of the obstruction.

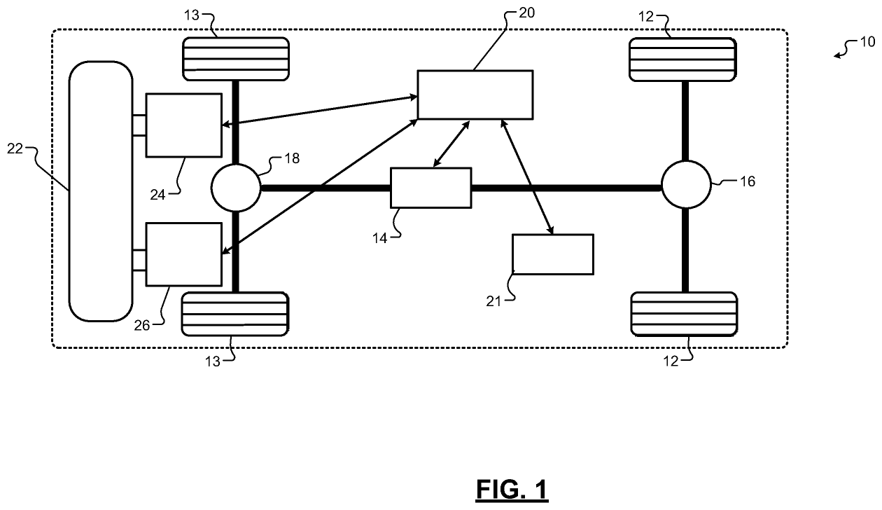

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel, an acceleration paddle, etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors 21 (such as cameras, microphones, pressure sensors, wheel position sensors, location sensors such as global positioning system (GPS) antennas, spoiler position sensors, spoiler actuator motor sensors, etc.). The vehicle control module 20 may communicate with another device via a wireless communication interface, which may include one or more wireless antennas for transmitting and/or receiving wireless communication signals.

For example, the wireless communication interface may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

As shown in FIG. 1, the vehicle 10 includes a spoiler 22. The spoiler 22 may be any suitable spoiler mounted to any suitable location of the vehicle, such as mounting on a liftgate at a rear of the vehicle. The spoiler 22 may be an active spoiler which is movable between multiple positions, such as a stowed position adjacent the surface of the vehicle (with a small or no gap between the spoiler of the vehicle), and a deployed position further from the surface of the vehicle (e.g., raised upwards from the stowed position). The spoiler 22 may also be located at any position intermediate of the stowed position and the deployed position, and may configured to rotate to change an angle of a surface of the spoiler 22 relative to ground or a direction of travel of the vehicle 10.

For example, a left spoiler actuator 24 and a right spoiler actuator 26 are coupled to drive movement of the spoiler 22. In other example embodiments, more or less spoiler actuators may be used, and may be coupled to other portions of the spoiler 22. Each spoiler actuator may include, for example, a solenoid actuator, an electric motor, etc.

In some example embodiments, the vehicle control module 20 is configured to control operation of the left spoiler actuator 24 and the right spoiler actuator 26. For example, the vehicle control module 20 may control the left spoiler actuator 24 and the right spoiler actuator 26 to move the vehicle spoiler, which may include controlling an amount of torque allowed by the left spoiler actuator 24 and the right spoiler actuator 26. The vehicle control module 20 may control the left spoiler actuator 24 and the right spoiler actuator 26 according to one or more vehicle parameters, such as parameters obtained via the vehicle sensors 21, parameters of the left spoiler actuator 24 and the right spoiler actuator 26, etc.

In some example embodiments, the vehicle control module 20 may implement closed loop control which utilizes multiple parallel algorithms to enhance pinch protection, optimize system performance, improve vehicle noise, vibration, harness (NVH) performance and quality, etc.

For example, the vehicle control module 20 may be configured to learn end stops of movement of the spoiler 22 (such as during initial installation of the spoiler 22 to the vehicle 10), and determine critical pinch zones by calculating the distance of the spoiler 22 from the end stop (e.g., where a spoiler angle is large enough to fit a 99th percentile human hand), etc.

The vehicle control module 20 may be configured to determine pinch risk hazard based on vehicle conditions with the use of various signals, such as vehicle speed, transmission State, liftgate Status, spoiler end stops, spoiler angle, etc. The vehicle state may be assessed for a possible pinch hazard, and the vehicle control module 20 may command rear spoiler actuation with an appropriate torque and target position to increase safety and performance of the system (e.g., by maintaining torque of the left spoiler actuator 24 and the right spoiler actuator 26 below a threshold torque value to decrease a force applied to an occupant or other person adjacent the vehicle in the event of a pinch).

Hardware protection of the spoiler may be implemented by utilization of vehicle state signals (e.g. sensed vehicle parameters) and the position of the rear liftgate (when the vehicle spoiler 22 is mounted on a liftgate of the vehicle), to add extra hardware protection to a rear active spoiler. The spoiler 22 may be commanded to retract if there is a risk of impacting a low ceiling threshold, and the vehicle control module 20 determines it is safe to do so to avoid user injury.

In some example embodiments, the vehicle control module 20 may be configured to evaluate and determine a pinch event of the spoiler 22, based on combined motor characteristics. For example, the vehicle control module 20 may monitoring Instantaneous motor current of the left spoiler actuator 24 and the right spoiler actuator 26 during each movement of the spoiler 22, and using the moving average to define an over current threshold.

The vehicle control module 20 may monitor motor speed to identify whether the motor of the left spoiler actuator 24 or the right spoiler actuator 26 is moving slower than the calibrated threshold, and may monitor a motor movement status (e.g., currently in motion or stopped) and compare a difference between a target position of the spoiler 22 and a current position of the spoiler 22.

The vehicle control module 20 may be configured to enable use of a declutch mechanism to determine when an output shaft is misaligned to the motor shaft within the left spoiler actuator 24 or the right spoiler actuator 26. The vehicle control module 20 may monitor any of these parameters (or others) to determine when a pinch event of the spoiler 22 may have occurred.

In some example embodiments, the vehicle control module may be configured to improve body alignment and flushness of the spoiler 22 to the fascia of the vehicle, by adjusting target positions of the left spoiler actuator 24 and the right spoiler actuator 26, by adjusting speed and torque targets, etc. This may quietly, reliably and safely position the spoiler 22 in a designated location, and may improve NVH performance using dynamic speed and torque control of the spoiler actuators.

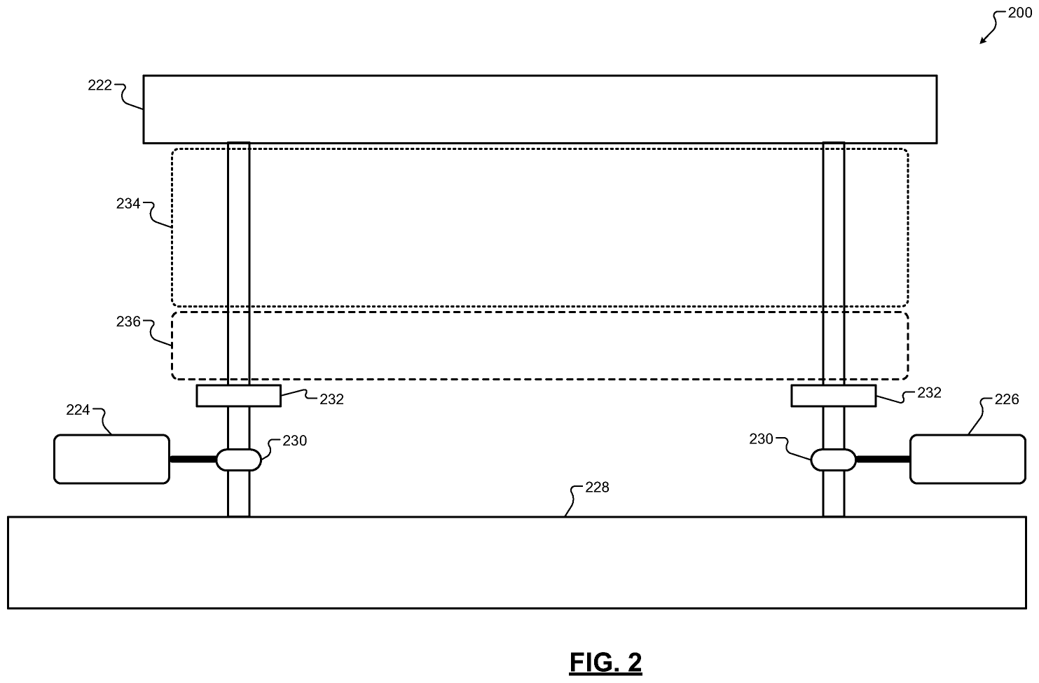

FIG. 2 is a block diagram of an example system 200 where a vehicle spoiler 222 is in a deployed position. The left spoiler actuator 224 is coupled to a left side portion of vehicle spoiler 222 via a coupler 230, and the right spoiler actuator 226 is coupled to the right side portion of the vehicle spoiler 222 via another coupler 230. For example, the vehicle spoiler 222 may be coupled to one or more mounts, rods, pillars, etc., which are moveable by the couplers 230 to raise and lower the vehicle spoiler relative to a vehicle surface 228.

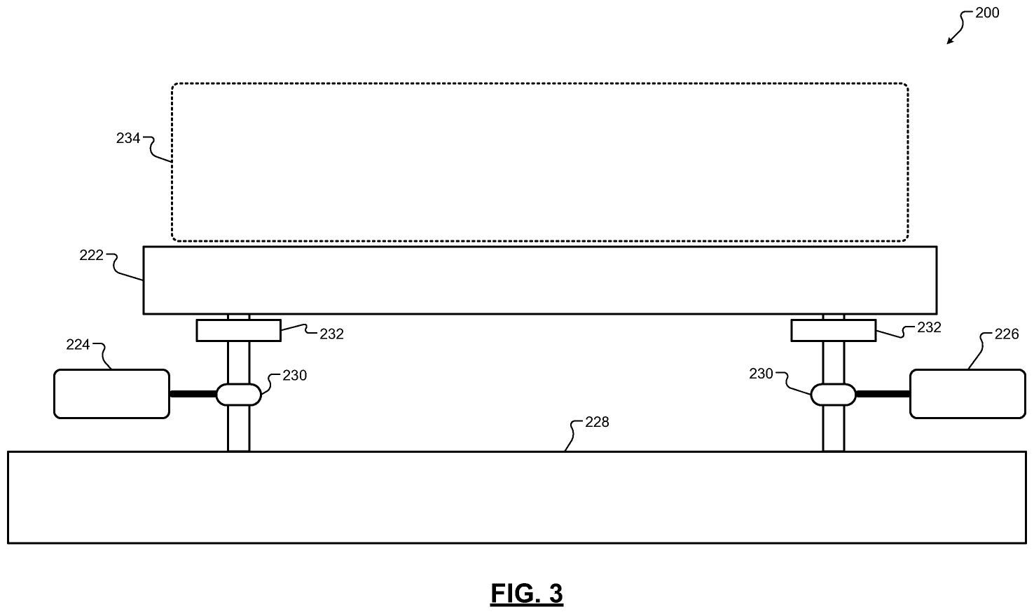

The system 200 incudes ends stops 232, which may represent a bottom movement position of the vehicle spoiler 232. For example, the left spoiler actuator 224 and the right spoiler actuator 226 may be configured to move the vehicle spoiler 222 to a stowed position (as shown in FIG. 3), adjacent the end stops 232.

The end stops 232 may be actual physical stop components that inhibit movement of the vehicle spoiler any further down, or may be indicative of a position where movement of the vehicle spoiler 222 is stopped to inhibit pressing the vehicle spoiler 222 into the vehicle surface 228.

In some example embodiments, the vehicle control module 20 may be configured to monitor a position of the vehicle spoiler 222 to determine whether a pinch risk condition is present. For example, the zone 234 may represent locations of the vehicle spoiler 222 where a pinch event could occur (e.g., if the vehicle spoiler 222 is lowering and a person sticks their hand in the zone 234 between the vehicle spoiler 222 and the vehicle surface 228.

If the vehicle spoiler 222 is determined to be in the zone 234 where a higher risk of a pinch condition is present, the left spoiler actuator 224 and the right spoiler actuator 226 may be operated with a low actuator torque setting to reduce the chances of a pinch event (because a person has more time to move their hand), or reduce a potential harm of a pinch event (because the actuators will not press the vehicle spoiler 222 down on a person with as much force).

The zone 236 may represent an area where a pinch risk is lower, such as when the vehicle spoiler 222 is close enough to the vehicle surface 228 (e.g., in the stowed position of FIG. 3), that a person would not have room to place their hand between the vehicle spoiler 222 and the vehicle surface 228.

In the zone 236, a higher torque setting of the left spoiler actuator 224 and the right spoiler actuator 226 may be used, because the risk of a pinch event is much lower (or approximately zero). The higher torque setting may allow the spoiler 222 to be brought in a full stowed position, for situations where a lower torque setting (such as the low torque setting of the zone 234) may not have enough power to fully seat the vehicle spoiler 222, etc.

In some example embodiments, the vehicle control module 20 may provide active spoiler control which utilizes a motor driver's instantaneous drive current value to provide real-time, sensor less pinch protection during motion of the vehicle spoiler 222, without compromising system performance. This may provide a less complex, and more cost-effective software solution (e.g., as opposed to adding extra motor and pinch sensing hardware), and may have a faster response rate to any detected pinch events.

The vehicle control module 20 may be configured to determine if a pinch hazard is present, and adjusts operation of the spoiler actuators accordingly (e.g., by reducing torque of the actuators when a pinch risk is above a threshold value). This approach facilitates improving or maximizing performance of the spoiler actuators in conditions when higher torque is desired or required due to external environmental loads (e.g., where higher torque is allowed at high vehicle speeds to hold the vehicle spoiler in a desired position to handle increased aerodynamic loads, because the risk of a pinch event is much lower while the vehicle is moving at high speeds).

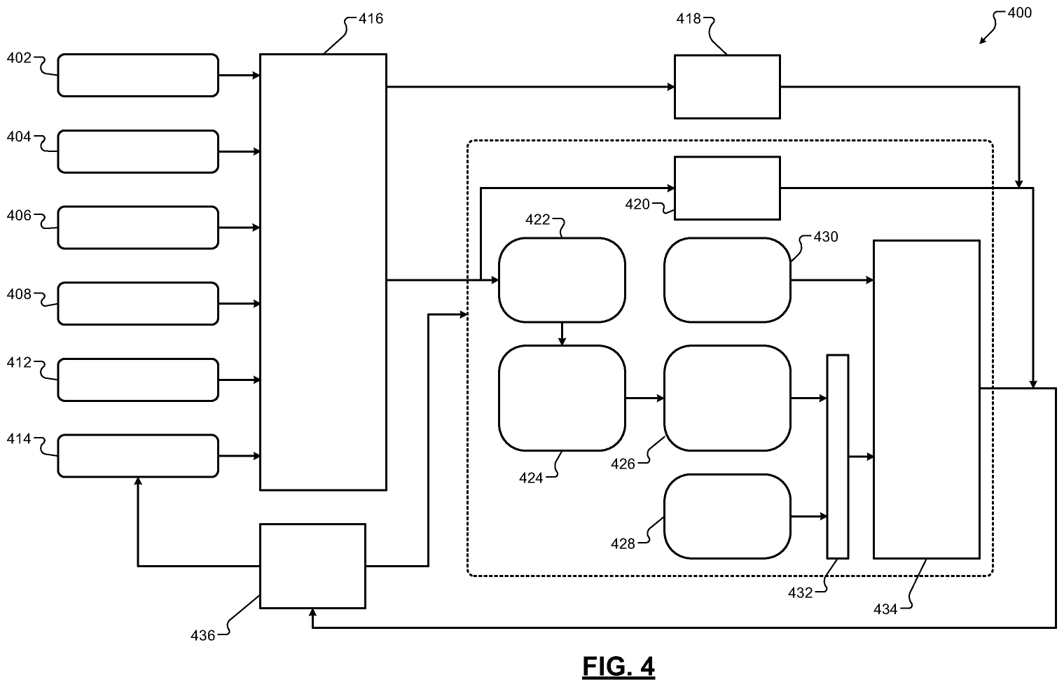

FIG. 4 is a block diagram of a control system 400 for determining whether a pinch risk condition is present based on vehicle parameters. The system 400 may be implemented on, for example, the vehicle control module 20 of FIG. 1.

As shown in FIG. 1, a pinch hazard determination module 416 may be configured to determine whether a risk of a pinch is above a specified threshold value, based on sensed vehicle parameters. The vehicle parameters may include, but are not limited to, a vehicle speed 402, a transmission state 404, a vehicle power mode 406, a liftgate status 408, a learned end stop 412, a spoiler position/motor status 414, etc.

If the pinch hazard determination module 414 determines that the risk of a pinch condition is below a threshold value (e.g., due to the vehicle spoiler being in a stowed position, due to the vehicle traveling at a high speed, etc.), the actuator(s) 436 of the vehicle spoiler are set to a high motor torque at 418. For example, the actuator(s) 436 may be allowed to operate up to torque values that are higher than torque values allowed when a pinch risk condition is above the threshold value.

As shown in FIG. 4, if the pinch hazard determination module 416 determines that a pinch hazard risk is above a threshold value and pinch protection is set to ON, the actuator(s) 436 are set to operate with a lower torque setting at 420, which is lower than the torque allowed at 418 when the pinch hazard is not present.

The system 400 also may determine whether a pinch event has occurred, via the pinch event determination module 434. For example, the system 400 may be configured to process current of the actuator(s) 436 during movement at 422, and determine a pinch threshold at 424 (e.g., based on the instantaneous motor current).

At 426, the system 400 determines whether the motor current moving average is above the threshold. If so, or if the system determines at 428 that an output shaft of the actuator(s) 436 is different than a motor angle, the pinch event determination module 434 may be configured to determine that pinch event has occurred (e.g., due to the OR operator 432).

The pinch event determination module 434 may be configured to determine whether the spoiler position is in a pinch risk zone at 430, to identify whether the control of the actuator(s) 436 should be modified (e.g., to stop a pinch event or provide relief from a pinch event).

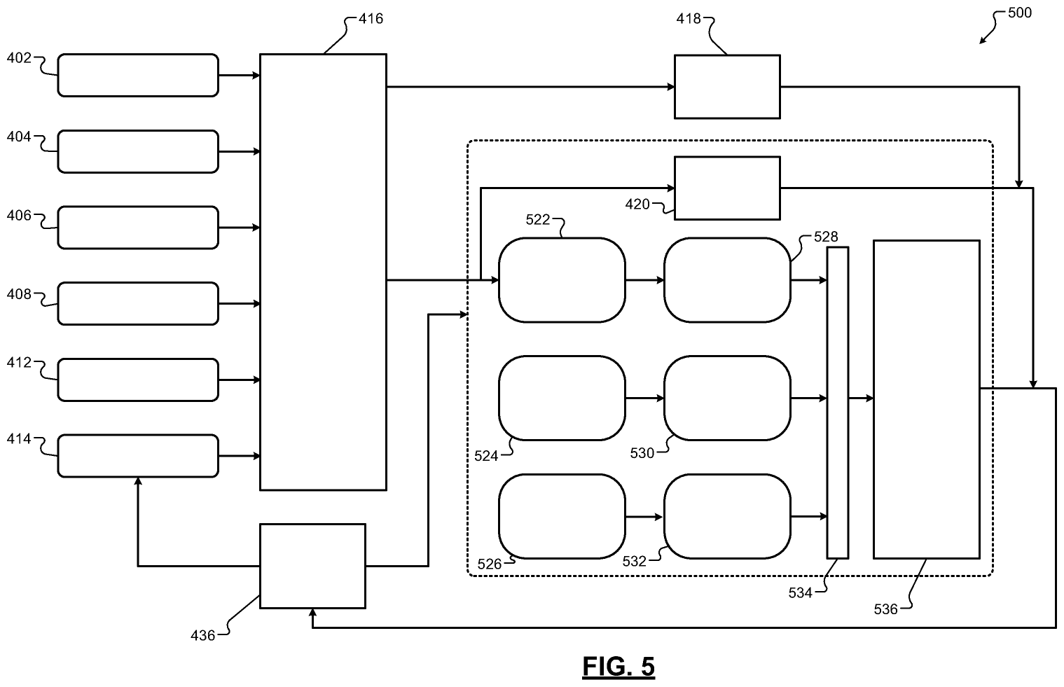

FIG. 5 is a block diagram of a control system 500 for determining whether a pinch hazard event has occurred. The system 500 may be similar to the system 400 of FIG. 4, and may include a motor movement control module 536 configured to adjust movement of the actuator(s) 436 according to sensed motor parameters of the actuator(s) 436.

For example, the system 500 may monitor movement status of a motor at 522, and determine whether a difference between a target position of the spoiler and a current position of the spoiler is greater than a threshold at 530. If the motor has stopped but the spoiler is not at the target position, this may indicate that a pinch event has occurred due to an obstruction preventing the vehicle spoiler from reaching the target position.

The system 500 may monitor motor speed at 524, and determine whether the motor speed is below a threshold at 532. For example, a motor speed below a threshold may indicate that a pinch event has occurred due to an obstruction inhibiting the motor from moving the vehicle spoiler above a target speed.

The system 500 may monitor motor speed at 524, and determine whether the position of a left actuator motor (and its corresponding left side of the spoiler) is different than a position of a right actuator motor (and its corresponding right side of the spoiler). If positions of the right and left sides are too far apart, it may indicate a pinch event due to an obstruction blocking one side of the spoiler.

If any of the above motor parameters indicate a possible pinch event, the motor movement control module 536 may receive the signals or indication via the OR operator 534, and adjust operation of the actuator(s) 436.

In various implementations, the vehicle control module may be configured to perform a learn cycle to learn end stops of the vehicle spoiler movement, to calculate critical pinch zones within the spoiler motion range. The vehicle control module may adjust the learned positions based on system performance, environmental conditions, etc.

The vehicle control module may be configured to use vehicle data (e.g., vehicle speed, transmission state, liftgate status, spoiler angle, etc.), to determine whether a pinch hazard may be present. The vehicle may dynamically adjust the motor torque of the spoiler actuator to achieve increased or optimal performance in normal conditions, as compared to conditions where a pinch hazard risk may be present.

In some example embodiments, the vehicle control module may monitor instantaneous motor characteristics during each movement of the vehicle spoiler, to evaluate performance and system issues. The vehicle control module may detect misalignment between the motor and the output shaft of the spoiler actuator(s), and use that information to improve pinch detection and occupant protection.

In some example embodiments, hardware protection may be implemented where, when a vehicle liftgate is open and/or the spoiler encounters an interference by a foreign object, operation of the spoiler actuator is stopped. The vehicle control module may implement control of spoiler actuator speed, torque and position, to adjust behavior based on immediate vehicle needs (e.g., fast operation of spoiler movement, quiet actuation, safe actuation to protect occupants or other person, etc.).

The vehicle control module may be configured to check for pinch hazard conditions based on vehicle state parameters, and sets motor performance limits accordingly (e.g., torque settings of spoiler actuators). If a pinch hazard risk is determined as possible or likely, the vehicle control module may calculate an instantaneous over current threshold using the average motor current (e.g., sampled for a given duration) at the beginning of each movement of the vehicle spoiler.

If during the movement of the vehicle spoiler the vehicle control module detects that the average current is increasing and is greater than the previously determined over current threshold, the vehicle control module may set a pinch detected flag which will turn off the motor.

After verifying the motor has safely stopped, the vehicle control module may calculate a new target position of the vehicle spoiler in order to relieve the pinch condition. This calculation may use the position and direction of the initial movement of the vehicle spoiler when the pinch event was detected, and determine the appropriate motor position/spoiler angle to safely relieve the pinch condition. The vehicle control module may reset the pinch detected flag to allow the system to operate with normal functionality after the pinch event is relieved.

If the vehicle control module determines that a pinch hazard risk is unlikely or is not expected, then the vehicle control module may allow a higher motor performance setting (e.g., a higher torque value of the spoiler actuator may be allowed). While in higher motor torque setting, the over current threshold may be set to a fixed value which is based on a maximum current/torque capability of the motor. This allows the system to overcome higher counter torque demand, which may be present due to the external environmental loads (e.g. higher aerodynamic loads on the vehicle spoiler at higher speeds).

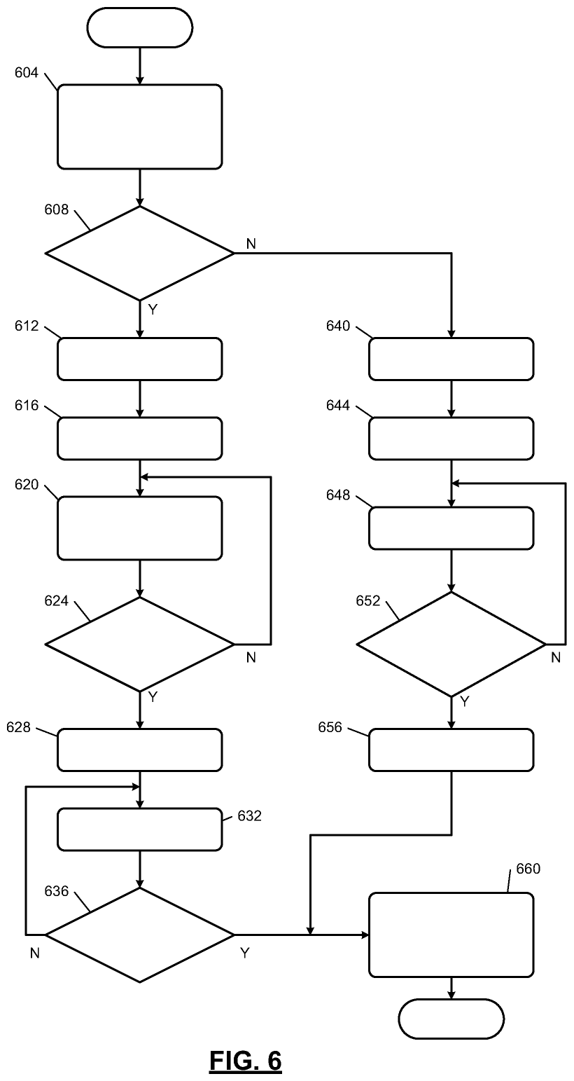

FIG. 6 is flowchart depicting an example method of controlling movement of a vehicle spoiler. The process may be performed by, for example, the vehicle control module 20 of FIG. 1. At 604, the process begins by determining a pinch hazard possibility based on vehicle state and speed (and/or any other suitable monitored vehicle parameters).

At 608, the vehicle control module is configured to determine whether a pinch hazard condition risk is greater than a threshold. If so, control sets a spoiler target position at 612, and sets a motor torque to a low value setting at 616. For example, the torque of the spoiler actuator(s) may be limited to at or below a low torque value corresponding to a safer torque value for possible pinch events of occupants or other persons.

At 620, the vehicle control module is configured to calculate a moving average of motor current. If the average motor current is greater not greater than a pinch threshold at 624, control returns to 620 to continue calculating a moving average of the motor current.

If control determines at 624 that the average motor current exceeds a threshold, control proceeds to 628 to turn off the motor (e.g., to avoid applying further force to a possible pinch event). The vehicle control module is configured to relieve the pinch at 632, such as by moving the spoiler in a reverse direction.

If the pinch relieve movement is not successful at 636, control returns to 632 to move the spoiler further to attempt to relieve the pinch condition. Once the pinch relief movement is successful at 636, control proceeds to 660 to display an obstruction detected signal and/or a service recommendation message (e.g., to let a driver know that a pinch event may have occurred and the spoiler should be checked for possible damage).

If control determines at 608 that a pinch hazard risk is not greater than a threshold, control proceeds to 640 to set a spoiler target position. The vehicle control module is configured to set the motor torque to a high value setting at 644, so that more force may be applied to move the spoiler when the risk of a pinch event is low or approximately zero.

At 648, the vehicle control module is configured to detect a motor current of the spoiler actuator. If the motor current exceeds a static maximum current threshold at 652, control proceeds to 656 to turn off the motor. Control then proceeds to 660 to display an obstruction detected signal and/or a service recommendation message.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle spoiler control system comprising:
a vehicle spoiler;
at least one spoiler actuator configured to move the vehicle spoiler relative to a surface of a vehicle;
one or more vehicle sensors configured to obtain at least one vehicle parameter; and
a vehicle control module configured to:
determine a spoiler pinch risk condition according to the at least one vehicle parameter;
control the spoiler actuator to operate with torque less than or equal to a first torque value in response to a determination that the spoiler pinch risk condition is greater than a threshold; and
control the spoiler actuator to operate with torque less than or equal to a second torque value in response to a determination that the spoiler pinch risk condition is greater less than the threshold, wherein the second torque value is greater than the first torque value.

2. The vehicle spoiler control system of claim 1, wherein the at least one vehicle parameter includes at least one of a vehicle speed, a vehicle transmission state, a vehicle liftgate status, a spoiler end stop position, or a spoiler angle.

3. The vehicle spoiler control system of claim 1, wherein:
the one or more vehicle sensors are configured to obtain a current of the at least one spoiler actuator; and
the vehicle control module is configured to compare the current of the at least one spoiler actuator to an overcurrent threshold to determine whether a pinch condition of the vehicle spoiler has occurred.

4. The vehicle spoiler control system of claim 3, wherein, in response to a determination that the pinch condition of the vehicle spoiler has occurred, the vehicle control module is configured to stop operation of the at least one spoiler actuator to inhibit further movement or rotation of the vehicle spoiler.

5. The vehicle spoiler control system of claim 4, wherein, in response to a determination that the pinch condition of the vehicle spoiler has occurred, the vehicle control module is configured to reverse operation of the spoiler actuator to move the vehicle spoiler to a target pinch relief position to relieve the pinch condition of the vehicle spoiler.

6. The vehicle spoiler control system of claim 1, wherein the vehicle control module is configured to use skip detection logic to determine whether an output shaft of the spoiler actuator and a motor angle of the spoiler actuator are misaligned, to stop operation the spoiler actuator to inhibit further movement or rotation of the vehicle spoiler.

7. The vehicle spoiler control system of claim 1, wherein:
the one or more vehicle sensors are configured to obtain one or more spoiler actuator parameters; and
the vehicle control module is configured to determine whether a pinch condition of the vehicle spoiler has occurred according to the one or more spoiler actuator parameters.

8. The vehicle spoiler control system of claim 7, wherein, in response to a determination that the pinch condition of the vehicle spoiler has occurred, the vehicle control module is configured to stop operation the spoiler actuator to inhibit further movement or rotation of the vehicle spoiler.

9. The vehicle spoiler control system of claim 7, wherein the at least one spoiler actuator includes:
a first spoiler actuator coupled to lift a first portion of the vehicle spoiler; and
a second spoiler actuator coupled to lift a second portion of the vehicle spoiler, the second portion located adjacent a different end of the vehicle spoiler than the first portion.

10. The vehicle spoiler control system of claim 9, wherein the one or more spoiler actuator parameters include at least one of a motor speed of at least one of the first spoiler actuator or the second spoiler actuator, a stopped motor of at least one of the first spoiler actuator or the second spoiler actuator, or a misalignment of the first spoiler actuator and the second spoiler actuator.

11. The vehicle spoiler control system of claim 1, wherein:
the at least one spoiler actuator is configured to move the vehicle spoiler from a deployed position to a stowed position; and
the vehicle spoiler is closer to the surface of the vehicle in the stowed position than in the deployed position.

12. The vehicle spoiler control system of claim 11, wherein:
the vehicle control module is configured to identify a first end stop of the vehicle spoiler in the stowed position and a second end stop of the vehicle spoiler in the deployed position; and
the vehicle control module is configured to determine the spoiler pinch risk condition at least in part according to a position of the vehicle spoiler relative to at least one of the first end stop and the second end stop.

13. A vehicle spoiler control system comprising:
a vehicle spoiler;
at least one spoiler actuator configured to move the vehicle spoiler relative to a surface of a vehicle;
one or more vehicle sensors configured to obtain at least one vehicle parameter; and
a vehicle control module configured to:
obtain a current of the at least one spoiler actuator;
compare the current of the at least one spoiler actuator to an overcurrent threshold to determine whether a pinch condition of the vehicle spoiler has occurred; and
in response to a determination that the pinch condition of the vehicle spoiler has occurred, stop operation of the at least one spoiler actuator to inhibit further movement or rotation of the vehicle spoiler.

14. The vehicle spoiler control system of claim 13, wherein, in response to a determination that the pinch condition of the vehicle spoiler has occurred, the vehicle control module is configured to reverse operation of the spoiler actuator to move the vehicle spoiler to a target pinch relief position to relieve the pinch condition of the vehicle spoiler.

15. The vehicle spoiler control system of claim 13, wherein the vehicle control module is configured to use skip detection logic to determine whether an output shaft of the spoiler actuator and a motor angle of the spoiler actuator are misaligned, to stop operation the spoiler actuator to inhibit further movement or rotation of the vehicle spoiler.

16. The vehicle spoiler control system of claim 13, wherein:
the one or more vehicle sensors are configured to obtain one or more spoiler actuator parameters; and
the vehicle control module is configured to determine whether a pinch condition of the vehicle spoiler has occurred according to the one or more spoiler actuator parameters.

17. The vehicle spoiler control system of claim 16, wherein, in response to a determination that the pinch condition of the vehicle spoiler has occurred, the vehicle control module is configured to stop operation the spoiler actuator to inhibit further movement or rotation of the vehicle spoiler.

18. A method of controlling movement of a vehicle spoiler, the method comprising:
moving, by at least one spoiler actuator, a vehicle spoiler relative to a surface of a vehicle;
obtaining, via one or more vehicle sensors, at least one vehicle parameter;
determining a spoiler pinch risk condition according to the at least one vehicle parameter;
controlling the spoiler actuator to operate with torque less than or equal to a first torque value in response to a determination that the spoiler pinch risk condition is greater than a threshold; and
controlling the spoiler actuator to operate with torque less than or equal to a second torque value in response to a determination that the spoiler pinch risk condition is greater less than the threshold, wherein the second torque value is greater than the first torque value.

19. The method of claim 18, further comprising:
obtaining, by the one or more vehicle sensors, a current of the at least one spoiler actuator;
comparing the current of the at least one spoiler actuator to an overcurrent threshold to determine whether a pinch condition of the vehicle spoiler has occurred; and
in response to a determination that the pinch condition of the vehicle spoiler has occurred, stop operation of the at least one spoiler actuator to inhibit further movement or rotation of the vehicle spoiler.

20. The method of claim 18, wherein the at least one vehicle parameter includes at least one of a vehicle speed, a vehicle transmission state, a vehicle liftgate status, a spoiler end stop position, or a spoiler angle.
